(19) United States
(12) Patent Application Publication
(10) Pub. No.: US 2013/0028423 A1
(43) Pub. Date: Jan. 31, 2013

(54) THREE DIMENSIONAL SOUND POSITIONING SYSTEM

(71) Applicants: GUIDO ODENDAHL, Wermelskirchen (DE); Bernd Odendahl, Wermelskirchen (DE)

(72) Inventors: GUIDO ODENDAHL, Wermelskirchen (DE); Bernd Odendahl, Wermelskirchen (DE)

(21) Appl. No.: 13/190,115

(22) Filed: Jul. 25, 2011

(51) Int. Cl. H04R 5/00

(52) U.S. Cl. 381/17

(57) ABSTRACT

A system and method provides three dimensional audio positioning. A user interface may comprise a sound space editor, a space effects editor, an input controller, an output controller, an animation path including a plurality of nodes in three dimensional space, and a timeline for defining timing of one or more audio signals through the animation path, and an output controller for providing output audio data from the user interface.

### BACKGROUND OF THE INVENTION

The present invention generally relates to a three dimensional (3D) sound positioning system. More specifically, the invention relates to a system and a method for positioning sound, a music track or other acoustic signal into an imaginary 3D space.

Development of so-called 3D sound has previously been limited to conventional 5.1 Dolby® surround speaker systems at a two dimensional level. The third dimension in space—namely above and below the listener, as well as the actual distance from a signal—can be represented only in a very limited capacity, or not at all. Strictly speaking, the three dimensional sound is not accurate in the systems currently being offered on the market.

Thus, there is a need for system and method that provides true 3D sound to provide for a more accurate 3D sound experience.

### SUMMARY OF THE INVENTION

In one aspect of the present invention, a system for providing three dimensional audio positioning may comprise a user interface that may comprise a sound space editor, a space effects editor, an input controller, an output controller, an animation path including a plurality of nodes in three dimensional space, and a timeline for defining timing of one or more audio signals through the animation path, and an output controller for providing output audio data to a set of audio components configured according to the animation path according to user input into the sound space editor, the space effects editor and the timeline.

In another aspect, a method may provide for three dimensional audio positioning, comprising receiving an audio signal, determining whether the audio signal is digital or analog, processing the audio signal according to said determining whether the audio signal is digital or analog, wave tracing the audio signal, editing the audio signal using a sound editor, wave modeling the audio signal, and providing an output signal.

These and other features, aspects and advantages of the present invention will become better understood with reference to the following drawings, description and claims;

### BRIEF DESCRIPTION OF THE DRAWINGS

FIG. 1 is a flow diagram illustrating steps performed by one embodiment;

FIG. 2 is a schematic diagram of components of the embodiment of FIG. 1; and

FIG. 3 is a typical screen-shot produced by the embodiment of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a three dimensional (3D) sound positioning system. The auricles or external ears are primarily responsible for human's ability to locate sound sources outside the x-axis. Their asymmetrical form modulates the sound waves in relationship to one another, enabling the brain to determine their position. The geometry of the ear may also be influenced by the resonance properties of the head, but only very slightly. One embodiment of software in the presently described system may calculate the pathway of the sound source to the inner ear using the wave tracing process. In this process, the human ears and their attributes are incorporated into the pursuit as polygonal geometry.

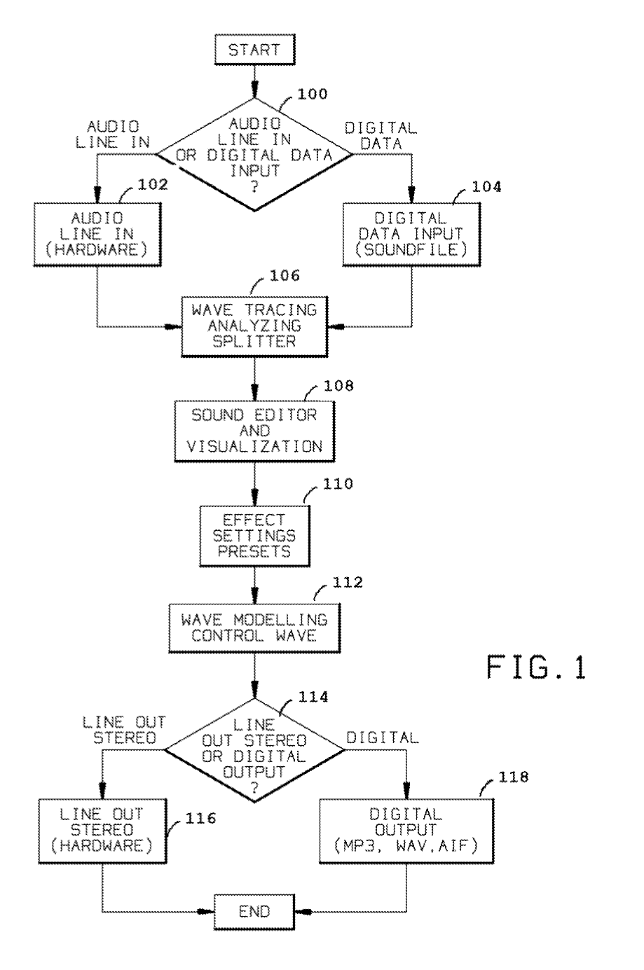

With reference to the FIG. 1, a flow diagram illustrates the steps that may be performed in a 3D sound positioning system according to one embodiment. In step 100, the system may check for whether the audio signal received is analog or digital. In step 102, if the audio was analog, then the signal may be processed by analog hardware. Alternatively, if the signal is digital, then the signal may be processed by digital processing hardware in step 104.

After processing, the signal may be processed by a wave tracing and analyzing splitter in step 106. The signal may next be processed by a sound editor and visualization application in step 108. Effect setting presets may then be added in step 110. In step 110, wave modeling of a control wave may next be performed in step 112. In decision box 114, it may be determined whether the signal produced by the previous steps is line out stereo-type or digital. If the signal type is line out stereo, then the signal may be processed by line out stereo hardware in step 116. Otherwise, the signal may be processed to produce a digital file in step 118. By way of example, and not by way of limitation, an mp3, wav, or aif file may be produced.

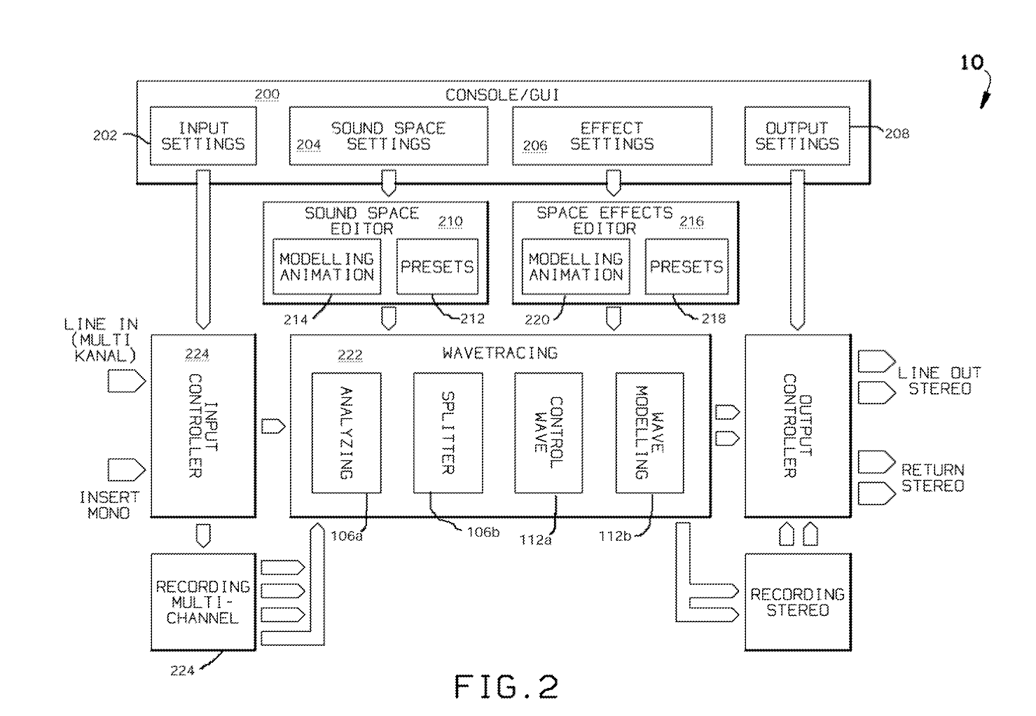

With reference to FIG. 2, a block diagram illustrates components that may be present in one embodiment of the system 10. A console or graphical user interface (GUI) 200 may be provided: The GUI 200, by way of example and not by way of limitation, may include an input settings area 202 for allowing a user to enter input settings, a sound space settings area 204 for allowing a user to input sound pace settings, an effect settings area 206 to allow a user to enter effect settings, and an output settings area 208 to allow a user to input output settings.

A sound space editor 210 may then receive sound space presents 212 to present sound space modeling animation 214, by which the user may manipulate the sound space for the system 10. In the same sense, a space effects editor 216 may then receive effect presents 218 and present space effects modeling animation 214, by which the user may manipulate the space effects for the system.

The output from the sound space editor 210 and the space effects editor 216 may be directed into a wave tracing module 222. The waive tracing module 222 may apply the outputs to the audio signal received by an input controller 224. The wave tracing module 222 applies the steps specified in FIG. 1 of wave tracing splitting and analyzing, sub-modules 106b and 106a respectively, and wave modeling and control waive processing in sub-modules 112b and 112a respectively. The input controller may receive line in and/or mono input. However, the wave tracing module 22 may receive muti-channel input 224 directly in one embodiment.

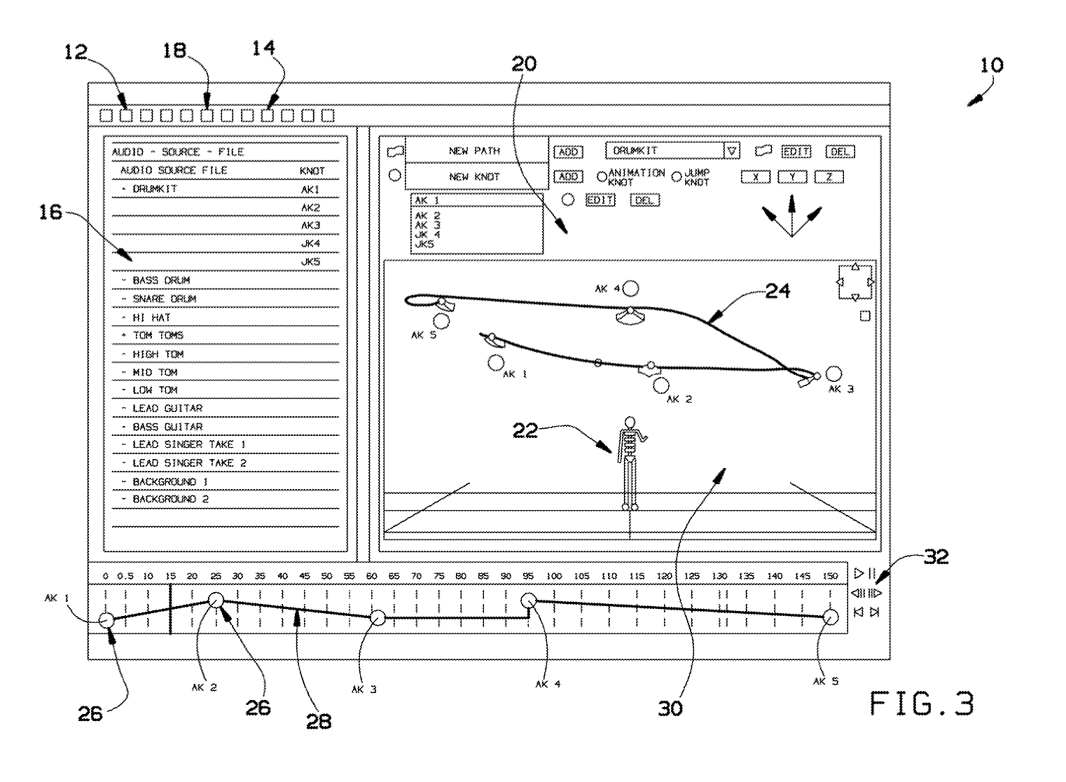

With reference to FIG. 3 a typical screen-shot that may be produced by one embodiment of the system 10 is shown. The screen, by way of example and not by way of limitation, may include selections for project administrations 12, temporary memory 14, and other administrative or processing windows 18. An audio input panel 16 on the screen allows the user to adjust settings for various input tracks. A node administrator 20 provides the user with the ability to define and adjust where audio nodes are placed in space. A node may be positioned within the space to indicate where one or more audio sources are located. One or more audio sources may be assigned to each node along a moving or animation path 24 indicated in the node administrator.

To move an audio source around within the space, a start point and endpoint may be specified. If the movement through the space is non-linear, additional points may be inserted between the start and end so that the audio source may move through the space in curved paths and at different heights. These points may form the animation path 24. The points may further broken down into A-nodes and J-nodes (animation nodes and jump nodes). Audio sources may be added to, or removed from, a specific node at any time. Nodes may be combined in node groups.

Node groups may let the user attach local movements within a global movement. An example would be a man speaking as a child runs around the man singing. It would first be necessary to animate the audio source child (local circular movement around the audio source man), while the audio source man operates again freely in the virtual space (global movement). Another example would be a singing child running around the speaking man on a moving bus which is moving back and forth, left and right.

The animation path 24 may comprise a start point, an endpoint and the nodes located in-between within a 3D view 30 on the screen. An object on the screen represents a person receiving the audio signals 22. All nodes may be connected to each other over a smoothed curve. Each node may further represent a reading point for a specific time on the timeline 28.

The timeline may be where the user defines the time for movement of the output signals along the animation path 24. The user may drag and define the nodes 26 along the time line to define such movement through the animation path 24. Regardless of the distance of the individual nodes to each other, the audio source may be set to move along the predetermined animation path from start to the other nodes according to the timeline. Time management buttons 32 may be used to assist in defining time of the audio signals around the animation path 24.

It should be understood, of course, that the foregoing relates to exemplary embodiments of the invention and that modifications may be made without departing from the spirit and scope of the invention as set forth in the following claims.

1. A system for providing three dimensional audio positioning, comprising:
a user interface comprising:
a sound space editor;
a space effects editor;
an input controller;
an output controller;
an animation path including a plurality of nodes in three dimensional space;
a timeline for defining timing of one or more audio signals through the animation path; and
an output controller for providing output audio data to a set of audio components configured according to the animation path, and according to user input into the sound space editor, the space effects editor and the timeline.

2. The system of claim 1, further comprising a wave tracing module.

3. The method of claim 2, wherein the wave tracing module comprises a wave modeling and control waive processing module.

4. The method of claim 3, wherein the wave tracing module further comprises a wave tracing splitting and analyzing module.

5. The method of claim 1, wherein the timeline has an start point and an end point to define the timing of the one or more audio signals through the animation path.

6. The method of claim 5, wherein the timeline further includes time management buttons.

7. A method for providing three dimensional audio positioning, comprising:
receiving an audio signal;
determining whether the audio signal is digital or analog;
processing the audio signal according to said determining whether the audio signal is digital or analog;
wave tracing the audio signal;
editing the audio signal using a sound editor;
wave modeling the audio signal; and
providing an output signal.

8. The method of claim 7, wherein the output signal is in stereo.

9. The method of claim 7, wherein the output signal is digital.

10. The method of claim 7, wherein the output signal is formatted according for space and time output among two or more nodes according to the steps of editing of the audio signal and wave modeling of the audio signal.
